(19) United States
(12) Patent Application Publication
(10) Pub. No.: US 2026/0170290 A1
(43) Pub. Date: Jun. 18, 2026

(54) HIERARCHICAL TIME SERIES FORECASTING

(71) Applicants: INTERNATIONAL BUSINESS MACHINES CORPORATION, ARMONK, NY (US); MASSACHUSETTS INSTITUTE OF TECHNOLOGY, CAMBRIDGE, MA (US)

(72) Inventors: Asterios Tsiourvas, Cambridge, MA (US); Wei Sun, Scarsdale, NY (US); Georgia Perakis, Belmont, MA (US); Pin-Yu Chen, White Plains, NY (US); Yada Zhu, Irvington, NY (US)

(21) Appl. No.: 18/984,896

(22) Filed: Dec. 17, 2024

(51) Int. Cl. G06N 3/04; G06N 3/08

(52) U.S. Cl. CPC G06N 3/04; G06N 3/08

(57) ABSTRACT

A computer implemented method for end-to-end hierarchical time series forecasting including receiving an input hierarchical time series data set, passing the input hierarchical time series data set through a base neural forecaster trained to generate a plurality of corresponding base forecasts, and passing the plurality of corresponding base forecasts through a neural network projection layer to generate a plurality of reconciled time series forecasts for the input hierarchical time series data set. The neural network projection layer is trained to reconcile the corresponding base forecasts via learning an improved oblique projection directly from the corresponding base forecasts, and the base neural forecaster and the neural network projection layer are part of a trained end-to-end forecasting model.

### BACKGROUND

### Technical Field

The present disclosure generally relates to hierarchical time series forecasting, and more particularly, to using neural networks for hierarchical time series forecasting by integrating a base neural forecaster with a learnable projection layer to ensure accurate and coherent forecasts across hierarchical levels.

### Description of the Related Art

Time series analysis and forecasting systems encompass methodologies and technologies designed to analyze temporal data and predict future values based on historical patterns. These systems leverage statistical techniques, and computational models to identify trends, seasonal variations, and cyclical behaviors within time series data. Applications of such systems span various domains, including healthcare, meteorology, and supply chain management, where forecasting is crucial for decision-making and strategic planning. By integrating large datasets and real-time processing capabilities, these systems attempt to enhance the ability to anticipate future events, optimize resource allocation, and improve operational efficiency.

However, conventional methods often rely on predefined projection matrices, which can be inflexible and may not adequately capture the unique characteristics of the data. This rigidity can lead to inconsistencies in forecasts, where aggregated forecasts do not align with original time series, undermining the reliability of the predictions.

Conventional approaches typically use orthogonal projections that treat all time series equally, failing to account for the varying importance or characteristics of individual series. This uniform treatment can result in suboptimal forecasts, as the method does not leverage the potential benefits of assigning different weights to different series. Additionally, the sequential nature of traditional forecasting methods, where base forecasts are generated first and then reconciled, can lead to inefficiencies and inaccuracies. The lack of an integrated, end-to-end learning process means that the reconciliation step does not benefit from the information available during the initial forecasting phase.

### BRIEF SUMMARY

According to an embodiment of the present disclosure, a method for end-to-end hierarchical time series forecasting includes receiving an input hierarchical time series data set and passing the input hierarchical time series data set through a base neural forecaster trained to generate a plurality of corresponding base forecasts. The plurality of corresponding base forecasts are passed through a neural network projection layer to generate a plurality of reconciled time series forecasts for the input hierarchical time series data set. The neural network projection layer is trained to reconcile the corresponding base forecasts via learning an improved oblique projection directly from the corresponding base forecasts, and the base neural forecaster and the neural network projection layer are part of a trained end-to-end forecasting model.

In one embodiment, the method includes configuring the neural network projection layer as a learnable, positive-definite, dense neural network layer to generate a general Euclidean projection.

In one embodiment, the method includes configuring the neural network projection layer as an arbitrary dense layer to generate a general oblique projection.

According to an embodiment of the present disclosure, a computing device includes a processor and a memory with computer program instructions that, when executed, enable the device to receive hierarchical time series data, process the data through a base neural forecaster to generate base forecasts, and then pass the base forecasts through a neural network projection layer to produce reconciled time series forecasts. The projection layer is trained to reconcile forecasts via an improved oblique projection. The base neural forecaster and the neural network projection layer are all part of a single end-to-end forecasting model.

According to an embodiment of the present disclosure, a computer program product for end-to-end hierarchical time series forecasting includes a computer-readable storage device and program instructions executable by a processor, comprising program instructions to receive an input hierarchical time series data set, pass the input hierarchical time series data set through a base neural forecaster to generate base forecasts, and pass the base forecasts through a neural network projection layer to produce reconciled forecasts. The projection layer is trained to reconcile base forecasts by learning an improved oblique projection. The base neural forecaster and the neural network projection layer are all part of a single end-to-end forecasting model.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a block diagram of a network of data processing systems in accordance with an illustrative embodiment.

FIG. 2 depicts a block diagram of a computing environment in accordance with an illustrative embodiment.

FIG. 3 illustrates an aspect of the subject matter in accordance with one embodiment.

FIG. 4 depicts a sketch of a hierarchical time series in accordance with an illustrative embodiment.

FIG. 5 depicts a sketch of an end-to-end forecasting model in accordance with one embodiment.

FIG. 6 depicts a diagram showing how reconciled forecasts are obtained in accordance with one embodiment.

FIG. 7 depicts a diagram showing how projections are used to produce reconciled forecasts in accordance with one embodiment.

FIG. 8 depicts a table illustrating different types of projections in accordance with one or more embodiments.

FIG. 9 depicts a routine for end-to-end hierarchical time series forecasting in accordance with one embodiment.

### DETAILED DESCRIPTION

### Overview and Benefits

According to an embodiment of the present disclosure there is provided a computer-implemented method for end-to-end hierarchical time series forecasting. An input hierarchical time series data set is received and passed through a base neural forecaster trained to generate a plurality of corresponding base forecasts. The plurality of corresponding base forecasts is passed through a neural network projection layer to generate a plurality of reconciled time series forecasts for the input hierarchical time series data set. The neural network projection layer is trained to reconcile the corresponding base forecasts via learning an improved oblique projection directly from the corresponding base forecasts, and the base neural forecaster and the neural network projection layer are part of a single end-to-end forecasting model. The method enhances the accuracy of hierarchical time series forecasting by utilizing a base neural forecaster and a neural network projection layer within a single end-to-end model. The projection layer learns to better (e.g., optimally) reconcile base forecasts, resulting in more precise and coherent time series predictions.

In one embodiment, the neural network projection layer is configured as a learnable positive-definite dense neural network layer to generate a general Euclidean projection, enhancing the model's ability to learn complex relationships and improving accuracy in Euclidean space projections.

In one embodiment, one or more positive-definite parameters of the learnable positive-definite dense neural network layer are achieved by training the layer via eigenvalue factorization, ensuring neural network layer maintains positive-definiteness, and enhancing stability and performance during training.

In one embodiment, the neural network projection layer is configured as an arbitrary dense layer to generate a general oblique projection, allowing for greater flexibility and adaptability in the neural network's functionality, enhancing its ability to handle diverse and complex data sets.

In one embodiment, the arbitrary dense layer is trained with a regularized loss function to enforce an idempotence property, ensuring the model maintains consistent outputs when the same input is processed multiple times.

In one embodiment, an aggregation matrix is predefined for transforming the output of the neural network projection layer into a plurality of reconciled time series. The aggregation matrix is predefined based on a hierarchical structure of the hierarchical time series. The predefining allows accurate transformation of neural network outputs into reconciled time series.

In one embodiment, the end-to-end forecasting model is configured to utilize various types of base neural forecasters, providing flexibility in forecasting by leveraging the strength s of various neural forecasters.

In one embodiment, the plurality of reconciled time series that are unbiased, therefore, eliminating bias in the reconciled time series and leading to more accurate and reliable data analysis.

According to an embodiment of the present disclosure, a computing device includes a processor and a memory in communication with the processor. The memory stores one or more computer program instructions that, when executed by the processor, cause the computing device to perform operations comprising receiving an input hierarchical time series data set. The operations further comprise passing the input hierarchical time series data set through a base neural forecaster trained to generate a plurality of corresponding base forecasts. The operations include passing the plurality of corresponding base forecasts through a neural network projection layer to generate a plurality of reconciled time series forecasts for the input hierarchical time series data set. The neural network projection layer is trained to reconcile the corresponding base forecasts via learning an improved oblique projection directly from the corresponding base forecasts. The base neural forecaster and the neural network projection layer are part of an end-to-end forecasting model. The computing device therefore leverages an end-to-end model that optimally reconciles base forecasts through learned projections to enable accurate and efficient time series forecasting.

In one embodiment, the execution of the program instructions by the processor further causes the computing device to configure the neural network projection layer as a learnable positive-definite dense neural network layer to generate a general Euclidean projection, enhancing the neural network's ability to learn and adapt to complex data structures, improving overall performance and accuracy.

In one embodiment, the computing device achieves one or more positive-definite parameters of the learnable positive-definite dense neural network layer by training the layer via eigenvalue factorization. The training maintains positive-definiteness and provides stability for the neural network.

In one embodiment, the execution of the program instructions by the processor further configures the computing device to set the neural network projection layer as an arbitrary dense layer, thereby generating a general oblique projection, allowing flexibility and adaptability of the neural network in processing diverse data inputs.

In one embodiment, the arbitrary dense layer is trained with a regularized loss function to enforce an idempotence property, allowing the model to maintain consistent outputs when the same input is provided multiple times, enhancing reliability and stability.

In one embodiment, the execution of the program instructions by the processor further configures the computing device to perform operations including predefining an aggregation matrix for use in transforming an output of the neural network projection layer into the plurality of reconciled time series. The aggregation matrix is predefined based on a hierarchical structure of the hierarchical time series and enhances the accuracy and coherence of time series data analysis.

In one embodiment, the computing device includes an end-to-end forecasting model configured to utilize various types of base neural forecasters, allowing the leveraging of the strengths of various neural forecasting techniques.

In one embodiment, the plurality of reconciled time series is unbiased, leading to more accurate and reliable data analysis.

According to an embodiment of the present disclosure, a computer program product for end-to-end hierarchical time series forecasting includes one or more computer-readable storage devices and program instructions stored on at least one of the one or more computer-readable storage devices, which are executable by a processor. The program instructions include instructions to receive an input hierarchical time series data set. The program instructions also include instructions to pass the input hierarchical time series data set through a base neural forecaster trained to generate a plurality of corresponding base forecasts. The program instructions further include instructions to pass the plurality of corresponding base forecasts through a neural network projection layer to generate a plurality of reconciled time series forecasts for the input hierarchical time series data set. The neural network projection layer is trained to reconcile the corresponding base forecasts via learning an improved oblique projection directly from the corresponding base forecasts. Both the base neural forecaster and the neural network projection layer are part of an end-to-end forecasting model. The computer program product therefore enables more accurate and cohesive hierarchical time series predictions through the use of the end-to-end model that optimally reconciles base forecasts.

In one embodiment, the computer program product further includes program instructions configured to set up the neural network projection layer as a learnable, positive-definite, dense neural network layer that generates a general Euclidean projection. The set up provides a neural network that performs more accurate and efficient Euclidean projections, enhancing overall model performance.

In one embodiment, the computer program product further includes program instructions configured to set up the neural network projection layer as an arbitrary dense layer, thereby generating a general oblique projection. The set up provides flexibility and adaptability for the neural network, improving its performance in various forecasting tasks.

In one embodiment, the computer program product further includes program instructions to predefine an aggregation matrix for transforming the output of the neural network projection layer into a plurality of reconciled time series. The aggregation matrix is predefined based on a hierarchical structure of the hierarchical time series and thus, enhances the accuracy and coherence of the time series data.

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring the present teachings.

It is recognized that hierarchical time series, referring to a collection of time series that follows a hierarchical aggregation structure, may be used across many domains, including retail, energy and utility sector, travel industry, etc. In forecasting, in addition to forecast accuracy, it may also be beneficial to ensure coherence, i.e., forecasts of each aggregation group being equal to the forecasts of the time series making up the group. Forecast reconciliation may attempt to achieve coherence by projecting base or initial forecasts into a space in which the base forecasts can be reconciled. Using projection methods with pre-defined projection matrices, wherein the same weights are be assigned to individual time series, may produce less flexible and more biased forecasts. Further, learning individual time series independently may not provide any guarantee of coherence.

Applicants have recognized that using an end-to-end approach in combination with projections learned directly from data may enable more accurate and efficient time series forecasting. Certain operations are described as occurring at a certain component or location in an embodiment. Such locality of operations is not intended to be limiting on the illustrative embodiments. Any operation described herein as occurring at or performed by a particular component, can be implemented in such a manner that one component-specific function causes an operation to occur or be performed at another component, e.g., at a local or remote engine respectively. In one embodiment, the method described herein, is implemented to execute on a particularly configured computing device or data processing system and provides substantial advancement of the functionality of that computing device or data processing system. Embodiments thus have the capacity to improve the technical field of time series forecasting using an end-to-end neural network forecasting model. For example, as opposed to using predefined matrixes and discrete sequential steps to forecast, the illustrative embodiments can utilize a trained neural network to dynamically, more flexible and more efficiently forecast reconciled time series from diverse sources of input hierarchical time series data sets, ensuring more precise and coherent time series predictions.

Importantly, although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

It should be appreciated that the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably processed manually by a human user.

The illustrative embodiments are described with respect to certain types of machines. The illustrative embodiments are also described with respect to other scenes, subjects, measurements, devices, data processing systems, environments, components, and applications only as examples. Any specific manifestations of these and other similar artifacts are not intended to be limiting to the disclosure. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures, therefore, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

### Example Data Processing Environment

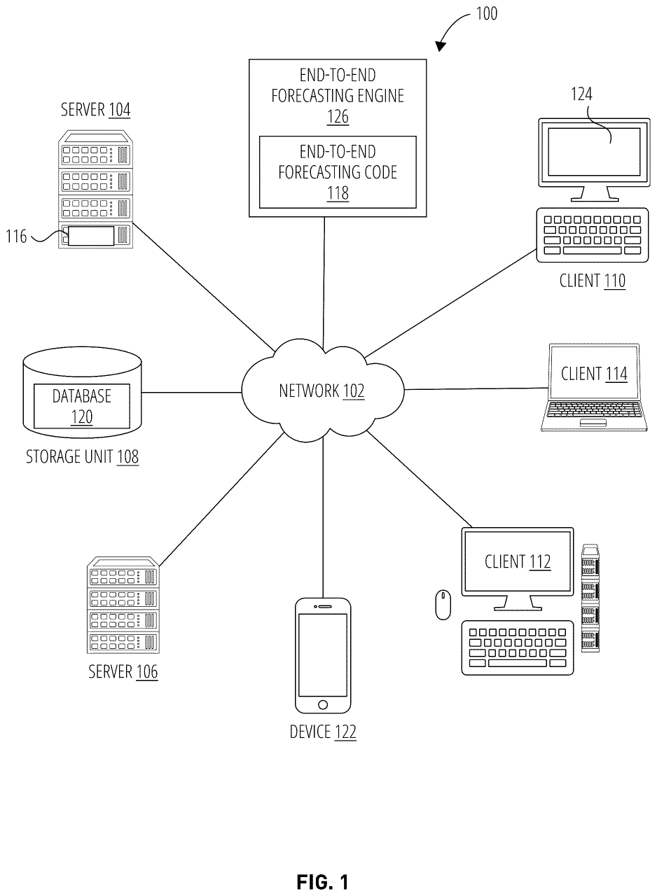

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Client 110, client 112, client 114 are also coupled to network 102. A data processing system, such as clients (client 110, client 112, client 114), end-to-end forecasting engine 126, server 104, server 106, and device 122, may include data and may have software applications or software tools executing thereon.

Only as an example, and without implying any limitation to such architecture, FIG. 1 depicts certain components that are usable in an example implementation of an embodiment. Data processing systems (end-to-end forecasting engine 126, server 104, server 106, client 110, client 112, client 114, and device 122) also represent examples in a cluster, partitions, and other configurations suitable for implementing an embodiment.

Server 104, server 106, storage unit 108, client 110, client 112, client 114, device 122, end-to-end forecasting engine 126 may couple to network 102 using wired connections, wireless communication protocols, or other suitable data connectivity. Client 110, client 112 and client 114 may be, for example, personal computers or network computers. Any of the clients may include a client application 124.

In the depicted example, the servers may provide data, such as boot files, operating system images, and applications to client 110, client 112, and client 114. Client 110, client 112 and client 114 may be clients to servers in this example. Client 110, client 112 and client 114 or some combination thereof, may include their own data, boot files, operating system images, and applications. Data processing environment 100 may include additional servers, clients, and other devices that are not shown. Server 104 may include a server application 116 that may be configured to implement one or more of the functions described herein in accordance with one or more embodiments. End-to-end forecasting engine 126 may also be a part of or separate from server 104 or server 106. Server application 116, and/or end-to-end forecasting engine 126 may include end-to-end forecasting code 118 configured for hierarchical time series predictions.

Device 122 is an example of a device described herein. For example, device 122 can take the form of a smartphone, a tablet computer, a laptop computer, client 110 in a stationary or a portable form, or any other suitable device. Database 120 of storage unit 108 may store one or more information for operations herein.

The data processing environment 100 may also be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service-oriented architecture where interoperable software components distributed across a network may be packaged together as coherent business applications. Data processing environment 100 may take the form of a cloud and employ a cloud computing model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

Various teachings of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 200 includes an example of an environment for the execution of at least some of the computer code involved in performing the inventive methods, such as end-to-end forecasting code 118. In addition to the end-to-end forecasting code 118, computing environment 200 includes, for example, Computer 202, wide area network 228 (WAN), end user device 230 (EUD), remote server 232, public cloud 240, and private cloud 236. In this embodiment, Computer 202 includes processor set 204 (including processing circuitry 206 and cache 208), communication fabric 210, volatile memory 212, persistent storage 214 (including operating system 216 and the end-to-end forecasting code 118, as identified above), peripheral device set 218 (including user interface (UI) device set 220, storage 222, and Internet of Things (IoT) sensor set 224), and network module 226. Remote server 232 includes remote database 234. Public cloud 240 includes gateway 238, cloud orchestration module 242, host physical machine set 246, virtual machine set 244, and container set 248.

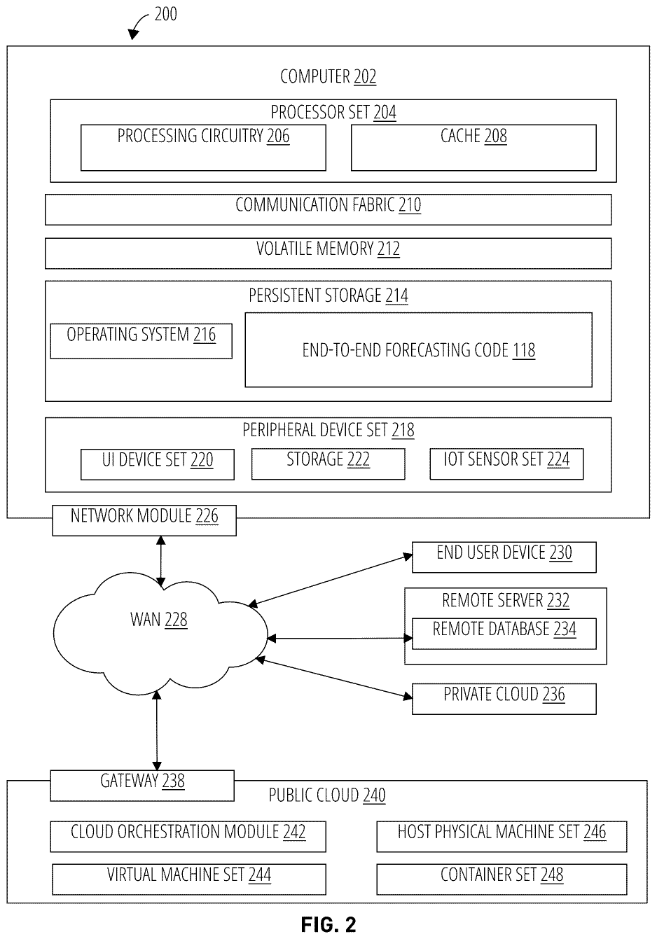

Computer 202 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 234. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically Computer 202, to keep the presentation as simple as possible. Computer 202 may be located in a cloud, even though it is not shown in a cloud in FIG. 2. On the other hand, Computer 202 is not required to be in a cloud except to any extent as may be affirmatively indicated.

Processor set 204 includes one, or more, computer processors of any type now known or to be developed in the future. Processing circuitry 206 may be distributed over multiple packages, for example, multiple, coordinated integrated circuit chips. Processing circuitry 206 may implement multiple processor threads and/or multiple processor cores. Cache 208 is memory that is located in the processor chip package(s) and is typically used for data or code that should be available for rapid access by the threads or cores running on processor set 204. Cache memories are typically organized into multiple levels depending upon relative proximity to the processing circuitry. Alternatively, some, or all, of the cache for the processor set may be located “off chip.” In some computing environments, processor set 204 may be designed for working with qubits and performing quantum computing.

Computer readable program instructions are typically loaded onto Computer 202 to cause a series of operational steps to be performed by processor set 204 of Computer 202 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 208 and the other storage media discussed below. The program instructions, and associated data, are accessed by processor set 204 to control and direct performance of the inventive methods. In computing environment 200, at least some of the instructions for performing the inventive methods may be stored in the end-to-end forecasting code 118 in persistent storage 214.

Communication fabric 210 is the signal conduction path that allows the various components of Computer 202 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, volatile memory 212 is characterized by random access, but this is not required unless affirmatively indicated. In Computer 202, the volatile memory 212 is located in a single package and is internal to Computer 202, but, alternatively or additionally, the volatile memory may be distributed over multiple packages and/or located externally with respect to Computer 202.

Persistent storage 214 is any form of non-volatile storage for computers that is now known or to be developed in the future. The non-volatility of this storage means that the stored data is maintained regardless of whether power is being supplied to Computer 202 and/or directly to persistent storage 214. Persistent storage 214 may be a read only memory (ROM), but typically at least a portion of the persistent storage allows writing of data, deletion of data and re-writing of data. Some familiar forms of persistent storage include magnetic disks and solid-state storage devices. Operating system 216 may take several forms, such as various known proprietary operating systems or open-source Portable Operating System Interface-type operating systems that employ a kernel. The code included in the end-to-end forecasting code 118 typically includes at least some of the computer code involved in performing the inventive methods.

Peripheral device set 218 includes the set of peripheral devices of Computer 202. Data communication connections between the peripheral devices and the other components of Computer 202 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 220 may include components such as a display screen, speaker, microphone, wearable devices (such as goggles and smart watches), keyboard, mouse, printer, touchpad, game controllers, and haptic devices. Storage 222 is external storage, such as an external hard drive, or insertable storage, such as an SD card. Storage 222 may be persistent and/or volatile. In some embodiments, storage 222 may take the form of a quantum computing storage device for storing data in the form of qubits. In embodiments where Computer 202 is required to have a large amount of storage (for example, where Computer 202 locally stores and manages a large database) then this storage may be provided by peripheral storage devices designed for storing very large amounts of data, such as a storage area network (SAN) that is shared by multiple, geographically distributed computers. IoT sensor set 224 is made up of sensors that can be used in Internet of Things applications. For example, one sensor may be a thermometer, and another sensor may be a motion detector.

Network module 226 is the collection of computer software, hardware, and firmware that allows Computer 202 to communicate with other computers through WAN 228. Network module 226 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 226 are performed on the same physical hardware device. In other embodiments (for example, embodiments that utilize software-defined networking (SDN)), the control functions and the forwarding functions of network module 226 are performed on physically separate devices, such that the control functions manage several different network hardware devices. Computer readable program instructions for performing the inventive methods can typically be downloaded to Computer 202 from an external computer or external storage device through a network adapter card or network interface included in network module 226.

WAN 228 is any wide area network (for example, the internet) capable of communicating computer data over non-local distances by any technology for communicating computer data, now known or to be developed in the future. In some embodiments, the WAN 228 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 230 is any computer system that is used and controlled by an end user (for example, a customer of an enterprise that operates Computer 202) and may take any of the forms discussed above in connection with Computer 202. EUD 230 typically receives helpful and useful data from the operations of Computer 202. For example, in a hypothetical case where Computer 202 is designed to provide a recommendation to an end user, this recommendation would typically be communicated from network module 226 of Computer 202 through WAN 228 to EUD 230. In this way, EUD 230 can display, or otherwise present, the recommendation to an end user. In some embodiments, EUD 230 may be a client device, such as thin client, heavy client, mainframe computer, desktop computer and so on.

Remote server 232 is any computer system that serves at least some data and/or functionality to Computer 202. Remote server 232 may be controlled and used by the same entity that operates Computer 202. Remote server 232 represents the machine(s) that collect and store helpful and useful data for use by other computers, such as Computer 202. For example, in a hypothetical case where Computer 202 is designed and programmed to provide a recommendation based on historical data, then this historical data may be provided to Computer 202 from remote database 234 of remote server 232.

Public cloud 240 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 240 is performed by the computer hardware and/or software of cloud orchestration module 242. The computing resources provided by public cloud 240 are typically implemented by virtual computing environments that run on various computers making up the computers of host physical machine set 246, which is the universe of physical computers in and/or available to public cloud 240. The virtual computing environments (VCEs) typically take the form of virtual machines from virtual machine set 244 and/or containers from container set 248. It is understood that these VCEs may be stored as images and may be transferred among and between the various physical machine hosts, either as images or after instantiation of the VCE. Cloud orchestration module 242 manages the transfer and storage of images, deploys new instantiations of VCEs and manages active instantiations of VCE deployments. Gateway 238 is the collection of computer software, hardware, and firmware that allows public cloud 240 to communicate through WAN 228.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 236 is similar to public cloud 240, except that the computing resources are only available for use by a single enterprise. While private cloud 236 is depicted as being in communication with WAN 228, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 240 and private cloud 236 are both part of a larger hybrid cloud.

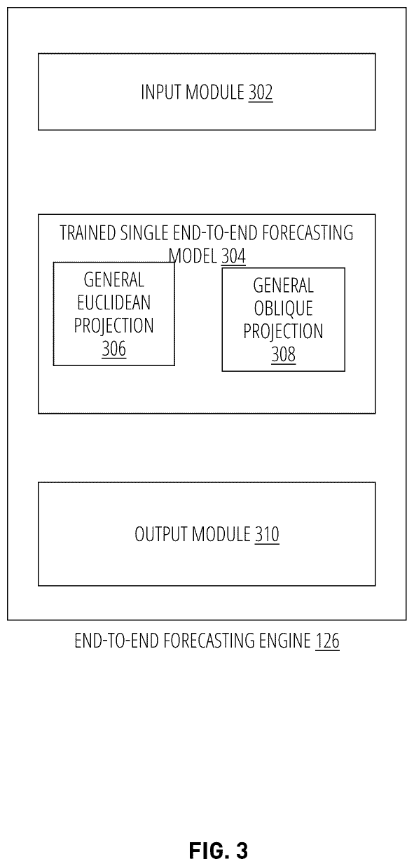

Reference is now made to FIG. 3 which illustrates an architecture of an end-to-end forecasting engine 126 in accordance with one or more embodiments. The end-to-end forecasting engine 126 may be operated based on end-to-end forecasting code 118 to perform hierarchical time series predictions as discussed herein. The end-to-end forecasting engine 126 comprises an input module 302, a trained end-to-end forecasting model 304, and an output module 310.

The input module is configured to an input hierarchical time series data set to be forecasted. The trained end-to-end forecasting model 304 is a trained neural network that is trained to predict reconciled time series corresponding to the input hierarchical time series data set. The trained end-to-end forecasting model 304 may comprise a plurality of component neural networks trained are trained together to receive the input hierarchical time series data set and produce the output predictions. As discussed hereinafter, the trained end-to-end forecasting model 304 comprises a base neural forecaster trained to generate a plurality of corresponding base forecasts; and a neural network projection layer trained to pass to generate from the corresponding base forecasts a plurality of reconciled time series forecasts for the input hierarchical time series data set. In particular, the neural network projection layer is trained to reconcile the corresponding base forecasts via learning an improved oblique projection directly from the corresponding base forecasts. The improved oblique projections can be obtained as either the general Euclidean projection 306 or the general oblique projection 308 as discussed hereinafter.

The output module 310 may receive the reconciled time series for display or further post processing.

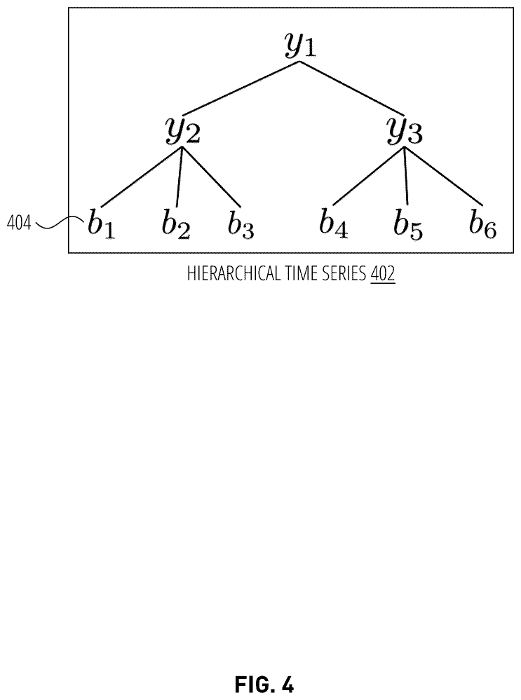

FIG. 4 illustrates an example hierarchical time series 402 in accordance with an illustrative embodiment. The hierarchical time series 402 is illustrated as a tree with a number of nodes (individual time series 404) n=9. More specifically, the hierarchical time series can be regarded as a collection of n variables indexed by time t, where t=1, . . . , T. The n-dimensional vector which includes observations of all variables in the hierarchy at time t can be denoted as: yₜ∈ [symbol] ⁿ, with y_{t,i}∈ [symbol] as the value of the i-th univariate time series at time t. The time series at the bottom of the hierarchy in FIG. 4 can be referred to as bottom-level series of dimension m, and the rest of the series as aggregated-level series of dimension r=n−m.

Based on this definition, yₜ can be expressed as [aₜbₜ]^{T}, where bₜ∈ [symbol] ^{m} and aₜ∈ [symbol] ^{n-m} represent the vectors of the bottom-level series and the aggregated-level series at time t respectively.

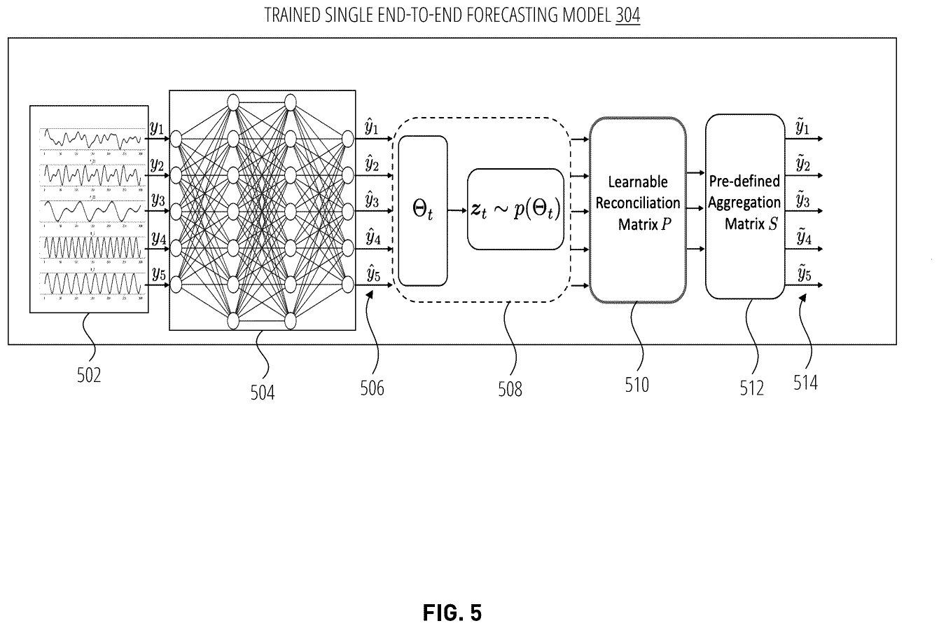

The indexing of each individual time series can be assumed to be given by the level-order traversal of the hierarchy going from left to right. Each hierarchical time series structure can be described by the aggregation matrix S={0,1}^{n×m} that is defined to satisfy that

$${y}_{t} = {Sb}_{t} ⇔ [ \begin{matrix}{a}_{t} \\ {b}_{t}\end{matrix} ] = [ \begin{matrix}{S}_{sum} \\ {I}_{m}\end{matrix} ] {b}_{t} , ∀ t ∈ [ T ] \qquad ( 1 )$$

where Sₛᵤₘ∈ [symbol] ^{r×m} is the summation matrix and Iₘ∈ [symbol] ^{m×m} is the identity matrix. The hierarchical time series 402 is further described with reference to FIG. 5.

FIG. 5 illustrates a trained end-to-end forecasting model 304 that receives a hierarchical time series 402 for hierarchical time series predictions. The trained end-to-end forecasting model 304 is configured to generate the hierarchical time series predictions in a single step. More specifically, though the trained end-to-end forecasting model 304 may include a plurality of neural networks, a loss function may be defined over the entire forecasting model.

The trained end-to-end forecasting model 304 comprises a base neural forecaster 504, a distribution parameters layer 508, a neural network projection layer 510, and an aggregation layer 512. In the end-to-end forecasting, the hierarchical time series 402 is prepared as an input hierarchical time series data set 502 which is passed through the base neural forecaster 504 to generate the plurality of base forecasts 506. The base forecasts 506 are potentially incoherent and may violate reconciliation and constraints of the forecasting and may therefore be reconciled as described hereinafter. The base forecasts 506 can be optionally sampled by the distribution parameters layer 508 prior to obtaining projections by the neural network projection layer 510. More specifically, while a learnable projection layer can be applied to both point and probabilistic forecasting methods, learning the distribution parameters and performing sampling may only be beneficial for the probabilistic forecasting.

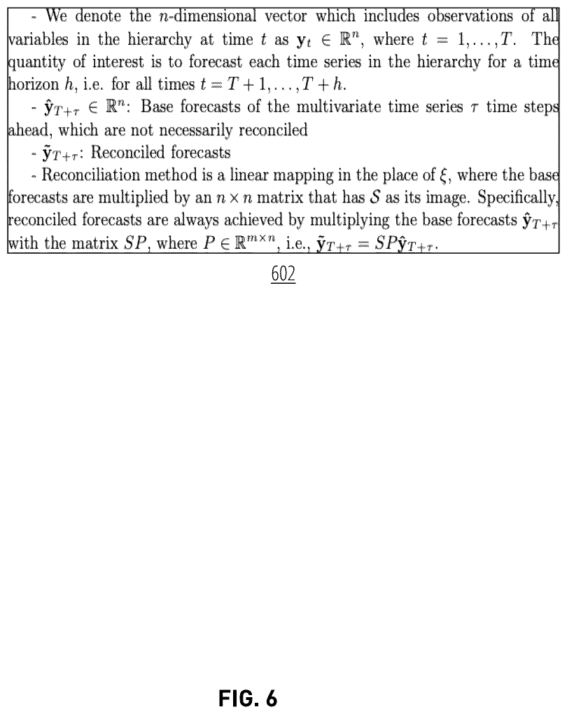

The neural network projection layer 510 is trained to reconcile the corresponding base forecasts via learning an improved oblique projection which allows a flexible structure with which the base forecasts 506 can be transformed into a space that enables reconciliation to be performed. The aggregation matrix S is used by the aggregation layer 512 along with the improved oblique projection to obtain the reconciled time series 514. The actions performed by the various components of the trained end-to-end forecasting model 304 are discussed in FIG. 6 to FIG. 9.

Turning now to FIG. 6, the reconciliation of base forecasts is described in conjunction with an input n-dimensional vector. As shown in the figure, the reconciled time series 514 are achieved by multiplying the base forecasts 506 with the matrix SP.

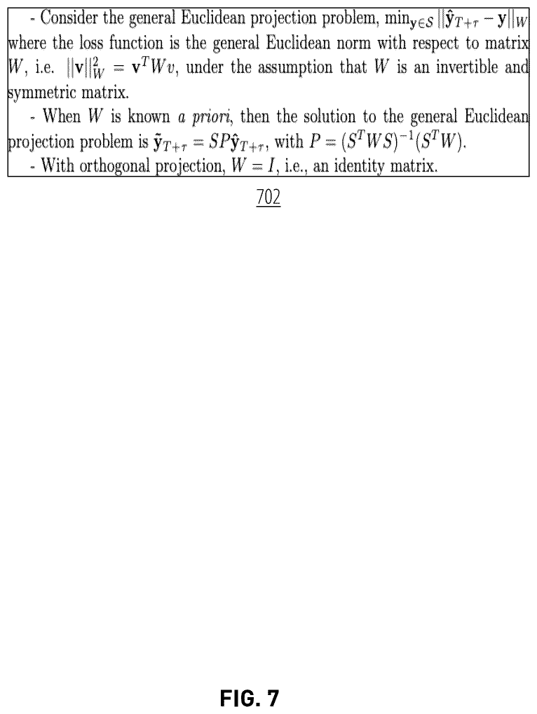

FIG. 7 shows that the forecasting, as shown in FIG. 5, can be cast as a projection problem. By minimizing the mean square error between predictions and the observations, the improved oblique projections can be learned to produce the reconciled time series 514.

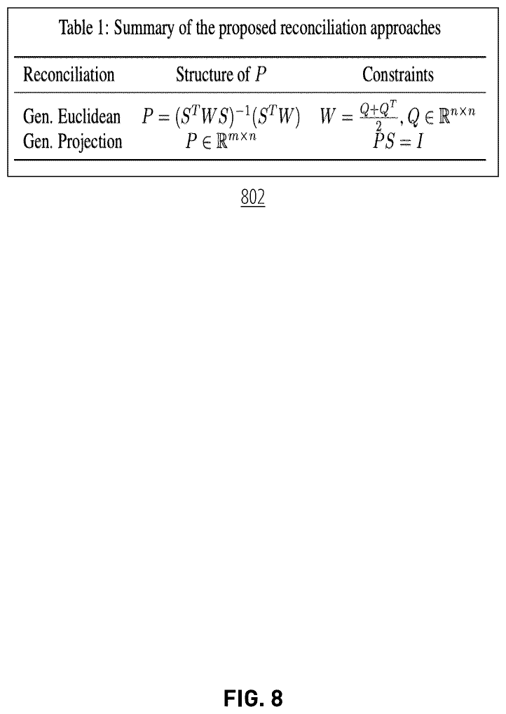

FIG. 8 illustrates two different reconciliation methods in which the reconciled time series 514 may be obtained. In a first method, the general Euclidean projection 306 is generated wherein the neural network projection layer 510 is configured as a learnable positive-definite dense neural network layer (a fully connected neural network which represents a positive definite matrix mathematically) for generating the general Euclidean projection 306. One or more positive-definite property of the learnable positive-definite dense neural network layer is achieved by training the learnable positive-definite dense neural network layer via eigenvalue-factorization.

More specifically, a structure is imposed on P=(S^{T}WS)⁻¹(S^{T}W), with W∈ [symbol] ^{n×n} to be a symmetric, positive-definite, dense neural network layer. To model symmetry, W=(Q+Q^{T})/2 is set, where Q is a learnable, positive-definite dense neural network layer. By this method, matrix W is always symmetric, while only a single matrix, Q is learned. To model the positive-definite parameter for Q, an eigenvalue factorization such as one proposed by the publication of Lezcano-Casado can be performed. (see Lezcano-Casado, M. Trivializations for gradient-based optimization on manifolds. In Advances in Neural Information Processing Systems, NeurIPS, pp. 9154-9164, 2019).

In a second method, any of a broad class of general oblique projection 308 can be generated wherein the neural network projection layer 510 is configured as an arbitrary dense layer (a dense layer initialized with random weights) for generating the general oblique projection 308. The arbitrary dense layer is trained with a regularized loss function to enforce an idempotence property. More specifically, for the general oblique projection 308, P can be modeled as an arbitrary dense layer with input dimension n and output dimension m. The complete model (base neural forecaster 504 and neural network projection layer 510) is then trained under the constraint (SP)²=SP. To impose the idempotence property, a Lagrange multiplier λ can be introduced to penalize the Frobenius norm ∥PS−I∥_{F} of the constraint PS=I, where I∈ [symbol] ^{m×m} is the identity matrix. The satisfaction of this constraint implies that SP is a general projection matrix onto S since if PS=I, then (SP)²=SPSP=S(PS)P=SIP=SP. In both methods, for base forecasts 506 that are unbiased, the reconciled time series 514 produced by the projections are also an unbiased prediction due to the property of having a projection matrix.

An end-to-end forecasting model can be trained into the trained end-to-end forecasting model 304 using various types of training data sets, including any hierarchical time series. Program code may extract various features from training data, the extracted features being utilized to develop a predictor function, or a hypothesis, which the program code utilizes as a machine learning model. In identifying various features in the training data, the program code may utilize various techniques including, but not limited to, mutual information, which is an example of a method that can be utilized to identify features in an embodiment. Other embodiments may utilize varying techniques to select features, including but not limited to principal component analysis, diffusion mapping, a Random Forest, and/or recursive feature elimination (a brute force approach to selecting features). The program code may utilize a machine learning algorithm to train the machine learning model including providing weights for the outputs, so that the program code can prioritize various changes based on the predictor functions that comprise the machine learning model. The output can be evaluated by a quality metric. By selecting a diverse set of training data, the program code can train the machine learning model to identify and weight various features of the input hierarchical time series. To utilize the machine learning model, the program code obtains (or derives) input data or features to generate an array of values to input into input neurons of a neural network. Responsive to these inputs, the output neurons produce an array that includes the reconciled time series 514 to be presented or used contemporaneously.

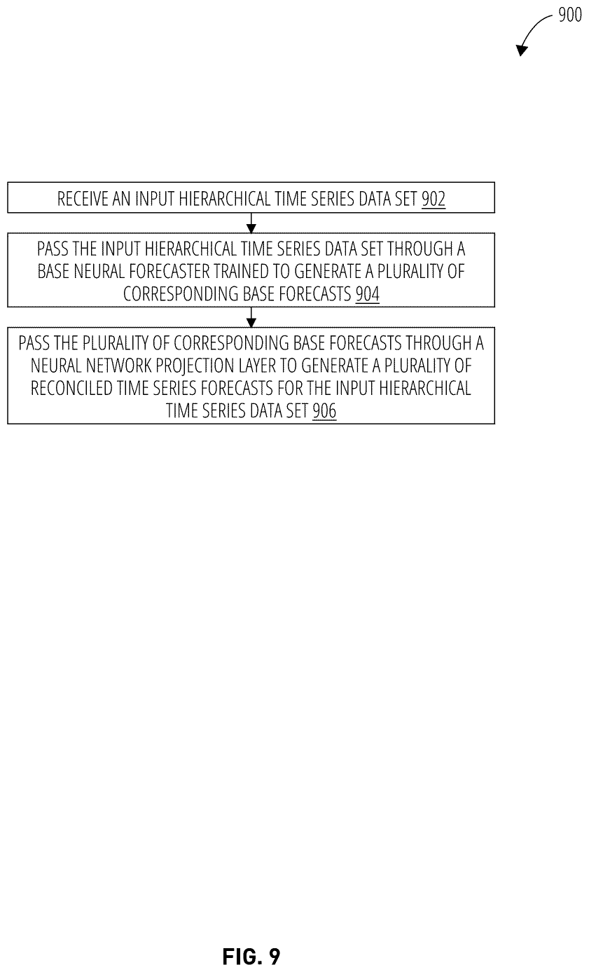

FIG. 9 illustrates a routine 900 for end-to-end hierarchical time series forecasting in accordance with an illustrative embodiment. The routine 900 may be performed with the end-to-end forecasting engine 126.

In block 902, the end-to-end forecasting engine 126 receives an input hierarchical time series data set 502. In block 904, the input hierarchical time series data set 502 is passed through a base neural forecaster 504 trained to generate a plurality of corresponding base forecasts. In block 906, the base forecasts 506 are passed through a neural network projection layer 510 to generate a plurality of reconciled time series 514 forecasts for the input hierarchical time series data set 502. The neural network projection layer 510 is trained to reconcile the base forecasts 506 via learning an improved oblique projection directly from the corresponding base forecasts. Further, the base neural forecaster 504 and the neural network projection layer 510 are part of a single end-to-end forecasting model that is trained to generate the reconciled time series 514 in a single step as opposed to sequential steps. In an embodiment, the single end-to-end forecasting model can use different types of base neural forecasters 504 such as the so-called “DeepVAR” (a multivariate, nonlinear generalization of classical autoregressive models) and “Autoformer” (decomposition transformers with auto-correlation for long-term series forecasting) base neural forecasters.

### CONCLUSION

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer implemented method for end-to-end hierarchical time series forecasting comprising:
receiving an input hierarchical time series data set;
passing the input hierarchical time series data set through a base neural forecaster trained to generate a plurality of corresponding base forecasts; and
passing the plurality of corresponding base forecasts through a neural network projection layer to generate a plurality of reconciled time series forecasts for the input hierarchical time series data set,
wherein:
the neural network projection layer is trained to reconcile the corresponding base forecasts via learning an improved oblique projection directly from the corresponding base forecasts; and
the base neural forecaster and the neural network projection layer are part of a trained end-to-end forecasting model.

2. The computer implemented method of claim 1, further comprising:
configuring the neural network projection layer as a learnable positive-definite dense neural network layer to generate a general Euclidean projection.

3. The computer implemented method of claim 2, wherein one or more positive-definite parameters of the learnable positive-definite dense neural network layer is achieved by training the learnable positive-definite dense neural network layer via eigenvalue factorization.

4. The computer implemented method of claim 1, further comprising:
configuring the neural network projection layer as an arbitrary dense layer, to generate a general oblique projection.

5. The computer implemented method of claim 4, wherein the arbitrary dense layer is trained with a regularized loss function to enforce an idempotence property.

6. The computer implemented method of claim 1, further comprising predefining an aggregation matrix for use in transforming an output of the neural network projection layer into the plurality of reconciled time series, wherein the aggregation matrix is predefined based on a hierarchical structure of the hierarchical time series.

7. The computer implemented method of claim 1, wherein the trained end-to-end forecasting model is configured to use different types of base neural forecasters.

8. The computer implemented method of claim 1, wherein the plurality of reconciled time series are unbiased.

9. A computing device comprising:
a processor; and
a memory, in communication with the processor, with one or more computer program instructions stored on the memory, the computer program instructions, when executed by the processor, cause the computing device to perform operations comprising:
receiving an input hierarchical time series data set;
passing the input hierarchical time series data set through a base neural forecaster trained to generate a plurality of corresponding base forecasts; and
passing the plurality of corresponding base forecasts through a neural network projection layer to generate a plurality of reconciled time series forecasts for the input hierarchical time series data set,
wherein:
the neural network projection layer is trained to reconcile the corresponding base forecasts via learning an improved oblique projection directly from the corresponding base forecasts; and
the base neural forecaster and the neural network projection layer are part of a trained end-to-end forecasting model.

10. The computing device of claim 9, wherein the execution of the program instructions by the processor further configures the computing device to perform operations comprising:
configuring the neural network projection layer as a learnable positive-definite dense neural network layer to generate a general Euclidean projection.

11. The computing device of claim 10, wherein one or more positive-definite parameters of the learnable positive-definite dense neural network layer is achieved by training the learnable positive-definite dense neural network layer via eigenvalue factorization.

12. The computing device of claim 9, wherein the execution of the program instructions by the processor further configures the computing device to perform operations comprising:
configuring the neural network projection layer as an arbitrary dense layer, to generate a general oblique projection.

13. The computing device of claim 12, wherein the arbitrary dense layer is trained with a regularized loss function to enforce an idempotence property.

14. The computing device of claim 9, wherein the execution of the program instructions by the processor further configures the computing device to perform operations comprising:
predefining an aggregation matrix for use in transforming an output of the neural network projection layer into the plurality of reconciled time series,
wherein the aggregation matrix is predefined based on a hierarchical structure of the hierarchical time series.

15. The computing device of claim 9, wherein the trained end-to-end forecasting model is configured to use different types of base neural forecasters.

16. The computing device of claim 9, wherein the plurality of reconciled time series are unbiased.

17. A computer program product for end-to-end hierarchical time series forecasting, the computer program product comprising:
one or more computer-readable storage devices and program instructions stored on the at least one of the one or more computer-readable storage devices, wherein an execution of the program instructions configures a computing device to perform a method comprising:
receiving an input hierarchical time series data set;
passing the input hierarchical time series data set through a base neural forecaster trained to generate a plurality of corresponding base forecasts; and
passing the plurality of corresponding base forecasts through a neural network projection layer to generate a plurality of reconciled time series forecasts for the input hierarchical time series data set,
wherein:
the neural network projection layer is trained to reconcile the corresponding base forecasts via learning an improved oblique projection directly from the corresponding base forecasts; and
the base neural forecaster and the neural network projection layer are part of a trained end-to-end forecasting model.

18. The computer program product for of claim 17, the method further comprising configuring the neural network projection layer as a learnable positive-definite dense neural network layer to generate a general Euclidean projection.

19. The computer program product for of claim 17, the method further comprising configuring the neural network projection layer as an arbitrary dense layer, to generate a general oblique projection.

20. The computer program product for of claim 17, the method further comprising predefining
an aggregation matrix for use in transforming an output of the neural network projection layer into the plurality of reconciled time series,
wherein the aggregation matrix is predefined based on a hierarchical structure of the hierarchical time series.
